(19) United States
(12) Patent Application Publication
(10) Pub. No.: US 2024/0338943 A1
(43) Pub. Date: Oct. 10, 2024

(54) SYSTEMS AND METHODS FOR UTILIZING MACHINE VISION TO VERIFY DISPATCH OF ITEMS

(71) Applicant: Capital One Services, LLC, McLean, VA (US)

(72) Inventors: Samuel Rapowitz, Roswell, GA (US); Renee Gill, New York, NY (US); Dennis Liu, Richmond, VA (US)

(21) Appl. No.: 18/296,015

(22) Filed: Apr. 5, 2023

(51) Int. Cl. G06V 20/40; G11B 27/34

(52) U.S. Cl. CPC G06V 20/41; G11B 27/34

(57) ABSTRACT

Disclosed embodiments can include a system for utilizing machine vision to verify dispatch of items. The disclosure provides a system having dispatch module comprising one or more processors and a memory storing instructions are configured to cause the dispatch module to perform a method. The method includes receiving a dispatch request for a first item. The method includes receiving, from a machine vision (MV) computing device, a first trigger of object recognition for the first item. The method includes initiating the first video comprising a process of packaging the first item. The method includes receiving a second trigger of label recognition associated with the first item. The method includes discontinuing the first video processing session. The method includes receiving a third trigger of label recognition associated with the first item. The method includes initiating a second video processing session to save a second video captured by the MV computing device.

The disclosed technology relates to systems and methods for utilizing machine vision to verify dispatch of items. Specifically, this disclosed technology relates to systems and methods for using machine vision headsets or other monitoring device to track, record, and review status of a request to dispatch an item to be shipped.

### BACKGROUND

When a customer makes a purchase that requires a product to be shipped, many logistical stakeholders are required to ensure the product makes it to its final destination—the customer's hands. These stakeholders include vendors, financial institutions communicating a purchase with the vendors, warehouses and distributors, and shipping/transport entities. Each stakeholder is an important part of the fulfillment of that purchase request. To date, however, communication between each of the stakeholders is lacking, as there is no current method to monitor, track, record, and review the physical status of a request to dispatch an item to be shipped.

This is particularly important for stakeholders such as financial institutions that often deal with scenarios where customers claim, either truthfully or not, that their purchased product did not arrive. This type of problem can result in what is known as a chargeback. A chargeback is when a customer disputes that a product was delivered to them, and then the financial institution investigates and returns funds back to the customer while debiting the vendor's account. This can be a pain point for all stakeholders: vendors can be leery of accepting credit cards for fear of chargebacks, the financial institution is hesitant to provide a chargeback because of this, but the financial institution also has interest in protecting the customer when the product was, in fact, not delivered to them. However, there is no current system or method that can be triggered to monitor the dispatch of that item from purchase to shipment (i.e., “fulfillment”) so as to provide a proof of the chain of custody of that product after the order. These and other problems exist.

### SUMMARY

The disclosed systems and methods herein provide solutions to the aforementioned problems. Disclosed embodiments can include a system for utilizing machine vision to verify dispatch of items. The system can include a dispatch module including one or more processors, and memory in communication with the one or more processors and storing instructions that, when executed by the one or more processors, are configured to cause the dispatch module to perform a process or method. The method can include receiving a dispatch request for a first item. The method can include receiving, from a machine vision (MV) computing device, a first trigger of object recognition for the first item. The method can include initiating, in response to receiving the first trigger, a first video processing session to save a first video captured by the MV computing device, the first video including a process of packaging the first item. The method can include receiving, from the MV computing device, a second trigger of label recognition associated with the first item. The method can include discontinuing, in response to receiving the second trigger, the first video processing session. The method can include receiving, from the MV computing device and subsequent to discontinuing the first video processing session, a third trigger of label recognition associated with the first item, the third trigger being associated with a transport request. The method can include initiating, in response to receiving the third trigger, a second video processing session to save a second video captured by the MV computing device, the second video including a process of finalizing the transport request.

Disclosed embodiments can additionally include another system for utilizing machine vision to verify dispatch of items. The system can include an MV computing device including a camera. The camera can scan for a first trigger of object recognition of a first item. The first trigger of object recognition can be an identification of an object resembling the first item completed by comparing the first item to a plurality of object images stored in a database. The camera can further capture a first video including a process of packaging the first item. The camera can further scan for a second trigger of label recognition. The system can further include a dispatch module including one or more processors and a memory in communication with the one or more processors and storing instructions that, when executed by the one or more processors, are configured to cause the dispatch module to perform a process or method. The method can include receiving a dispatch request for the first item. The method can include receiving, from the MV device, the first trigger. The method can include initiating, in response to receiving the first trigger, a first video processing session to save the first video. The method can include receiving, from the MV computing device, the second trigger. The method can include discontinuing, in response to receiving the second trigger, the first video processing session.

Disclosed embodiments can additionally include another system for utilizing machine vision to verify dispatch of items. The system can include a first MV computing device comprising a first camera. The first camera can scan for a first trigger of object recognition of a first item. The first camera can further capture a first video comprising a process of packaging the first item. The first camera can further scan for a second trigger of label recognition. The system can further include a second MV computing device comprising a second camera. The second camera can scan for a third trigger of label recognition associated with the first item. The third trigger can be associated with a transport request. The second camera can further capture a second video comprising a process of finalizing the transport request. The system can further include a dispatch module including one or more processors and a memory in communication with the one or more processors and storing instructions that, when executed by the one or more processors, are configured to cause the dispatch module to perform a process or method. The method can include receiving a dispatch request for the first item. The method can include receiving, from the first MV device, the first trigger. The method can include initiating, in response to receiving the first trigger, a first video processing session to save the first video. The method can include receiving, from the first MV computing device, the second trigger. The method can include discontinuing, in response to receiving the second trigger, the first video processing session. The method can include receiving, from the second MV computing device and subsequent to discontinuing the first video processing session, the third trigger. The method can include initiating, in response to receiving the third trigger, a second video processing session to save the second video.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for utilizing machine vision to verify dispatch of items in accordance with certain embodiments of the disclosed technology.

FIG. 2 is a flow diagram illustrating an exemplary method for utilizing machine vision to verify dispatch of items in accordance with certain embodiments of the disclosed technology.

FIG. 3 is a flow diagram illustrating an exemplary method for utilizing machine vision to verify dispatch of items in accordance with certain embodiments of the disclosed technology.

FIG. 4 is block diagram of an example dispatch module used to provide utilizing machine vision to verify dispatch of items, according to an example implementation of the disclosed technology.

FIG. 5 is block diagram of an example system that can be used to provide utilizing machine vision to verify dispatch of items, according to an example implementation of the disclosed technology.

### DETAILED DESCRIPTION

Examples of the present disclosure related to systems and methods for utilizing machine vision to verify dispatch of items. More particularly, the disclosed technology relates to analyzing images captured by a machine vision (MV) headset that includes a camera that enables the system to identify objects in the line of sight of the wearer. The wearer, for example, can be a person working to package an ordered product and set the product to the side to be delivered to the shipping party. A benefit of the present disclosure is that it provides, in at least one embodiment, a system that can automatically begin recording and saving a video stream from the MV headset upon the MV headset recognizing an object, i.e., a trigger of object recognition. The system can maintain a database of information related to objects scanned, such that the system can train and retrain a machine learning model (MLM) to identify objects captured by the MV computing device and associate them with one or more known items of the database. The MLM can learn in response to receiving another trigger of label recognition, as in a trigger that indicates that (a) the person packing the item agreed that the product was the accurate item, and (b) the person packing the item scanned a shipping label, thereby indicating that the product was the accurate item and is approved to ship. Using a machine learning model in this way can allow the system to remove any type of analog user input to identify when to start recording the fulfilment/dispatch process. This is a clear advantage and improvement over technologies that may require a user to identify an item, select to record the item, and then stop recording the item when it is packaged. The present disclosure solves this problem by improving upon image processing technologies to complete a task. Overall, the systems and methods disclosed have significant practical applications in the image processing field because of the noteworthy improvements to imaging and data analysis, which are important to solving present problems with this technology.

Another benefit of the present systems and methods is that they provide an image capturing and processing regime that relies on MV computing devices, such as headsets, that can analyze stimuli, i.e., triggers of label and object recognition, to automatically initiate video processing sessions. In doing so, the system and methods is able to rely on specific hardware and software to obviate the need for analog, manual, and user-involved steps to record and track processes in a fulfillment request.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

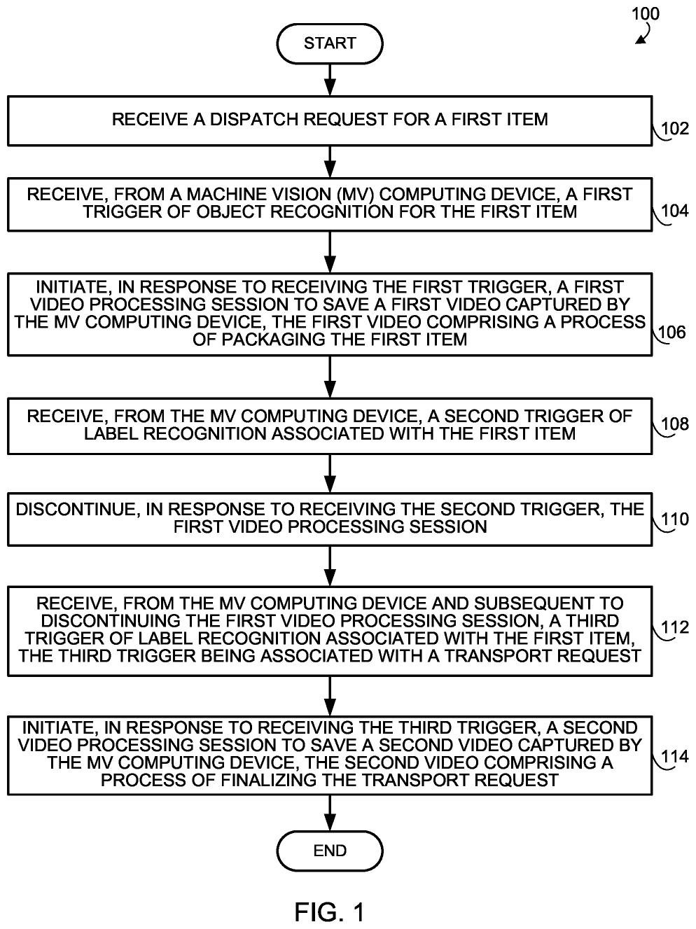

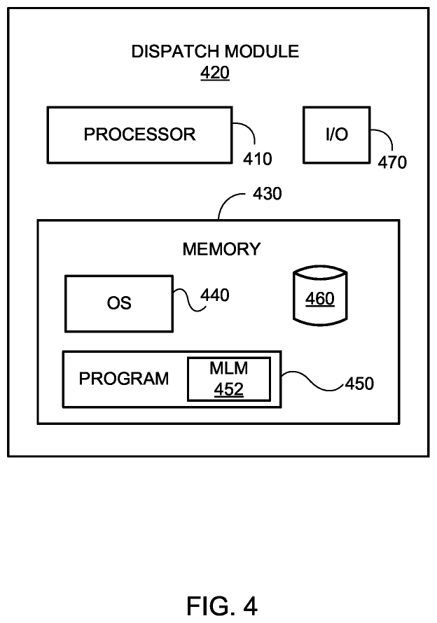

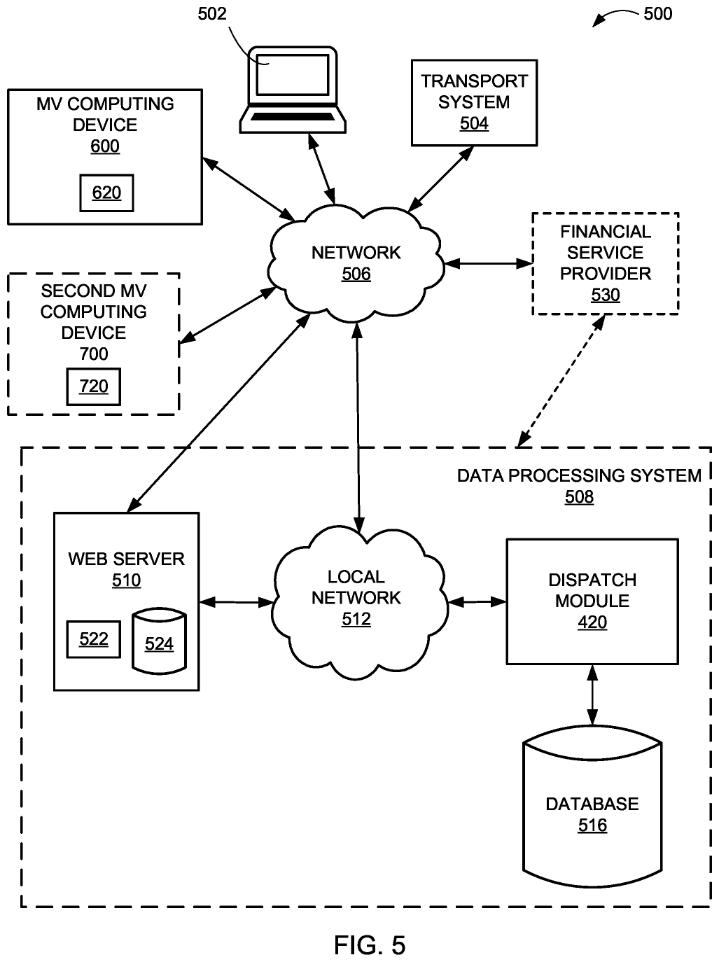

FIG. 1 is a flow diagram illustrating an exemplary method 100 for utilizing machine vision to verify dispatch of items, in accordance with certain embodiments of the disclosed technology. The steps of method 100 can be performed by one or more components of the 500 (e.g., dispatch module 420, web server 510 of data processing system 508, user device 502, and/or MV computing device 600), as described in more detail with respect to FIGS. 4 and 5.

In block 102, the dispatch module 420 can receive a dispatch request for a first item. A dispatch request is defined herein as a request to fulfill an ordered item, i.e., a fulfillment request. This fulfillment request can be a purchase order sent to the dispatch module 420 in response to a user making a purchase. For example, a customer may purchase a new computer on an online retailer (e.g., Amazon®), and the retailer sends a dispatch request to the dispatch module 420 to package the computer and send it out for shipment to the customer. In this manner, the dispatch module 420 can be associated with the backend system of a fulfillment center. In some examples, that fulfillment center can be a different entity than, or can be operated by an entity other than, the online retailer, or in some examples the online retailers can operate the fulfilment center/dispatch module 420.

In block 104, the dispatch module 420 can receive, from a machine vision (MV) computing device (e.g., MV computing device 600), a first trigger of object recognition for the first item. An MV computing device is a device that includes hardware and software that makes the device capable of capturing and processing images directed to a particular task. In the case of the present disclosure, the images captured and processed are those of a video feeds of the fulfillment, or dispatch, of the item(s) related to the dispatch request in block 102. In some examples, the MV computing device 600 can be a standalone device that a user who is dispatching the item(s) can operate by selecting when to video record on the device. In preferred embodiments, the MV computing device 600 can be tethered to the user and can contain a camera to capture and process images of the dispatch steps. For example, the MV computing device 600 can be a headset with an integrated camera (e.g., camera 620). The camera 620 can be configured to (i) scan for an object to be dispatched, (ii) scan for a trigger of label recognition, and (iii) capture videos of packaging the item and setting it out for delivery to a transport system.

Referring to the first trigger of object recognition for the first item, the first trigger can be a label associated with the first item. This can be, for example, a barcode, including linear- or matrix-barcodes, that identify the item. In the case that the MV computing device 600 is a headset, the MV computing device 600 can receive a first trigger if a barcode or other label identifier of the first item enters the field of vision of the camera 620. This product information associated with the label can be maintained by a database (e.g., dispatch module database 460 or web server databases 524) and be linked to the first item. When the dispatch request in block 102 is received, the dispatch module 420 can standby awaiting confirmation that the label associated with the first item is to be scanned for dispatch. The first trigger, therefore, is the dispatch module 420 identifying that the label associated with the first item entered the view of the camera 620.

In other examples, the first trigger of object recognition for the first item can be an identification, by the MV computing device 600, of an object resembling the first item. In this manner, the database (e.g., dispatch module database 460 or web server databases 524) can maintain data on the actual, physical representation of the items to be fulfilled. This can be data associated with box shape, logos, colors, etc., and/or product shapes, logos, colors, etc. This example can be beneficial in that it may avoid the need to ensure that a product label (e.g., barcode) is directly in the field of view of the MV computing device 600.

In some examples, the dispatch module 420 can also operate a machine learning model (MLM) that can be trained to identify objects captured by the MV computing device and associate them with one or more items. For example, the MV computing device 600 can begin recording the dispatch of the item when it sees an object and, if the user/system confirms it is an accurate item for the particular dispatch request (see block 102), the system can learn from that interaction that the product in the field of view is associated with the item in the dispatch request. Stated otherwise, the MLM can learn in response to receiving a second trigger of label recognition (see block 108, discussing how the second trigger of label recognition can be a printout of a shipping label), thereby indicating to the dispatch module 420 that the object resembles the first item.

In block 106, the dispatch module 420 can initiate, in response to receiving the first trigger, a first video processing session to save a first video captured by the MV computing device 600. This triggering of the first video processing session can be a step of informing the dispatch module 420 start video recording/saving can begin. In this manner, a database (e.g., dispatch module database 460 or web server databases 524) does not need to record all images captured by the MV computing device 600, but only the images that begin when the MV computing device 600 identifies the item to be fulfilled. As stated herein, the first video can be a video of a worker packaging the first item, or if the process is automated, a video of a machine packaging the first item.

In block 108, the dispatch module 420 can receive, from the MV computing device 600, a second trigger of label recognition associated with the first item. The second trigger of label recognition associated can be an image captured by the camera 620 of the MV computing device 600 that shows a shipping label in the field of view of the camera 620. Once the item to be fulfilled is fully packaged, the distribution center can then add a shipping label as a final step of packaging, indicating that the item in the package is the correct item and ready to be fulfilled. In block 110, therefore, the dispatch module 420 can discontinue, in response to receiving the second trigger, the first video processing session.

In block 112, the dispatch module 420 can receive, from the MV computing device 600 and subsequent to discontinuing the first video processing session, a third trigger of label recognition associated with the first item. The third trigger can be associated with a transport request. The transport request can be, for example, when the package is provided to a shipper (e.g., transport system 504) or when the package is set at a location in a warehouse for pickup by the shipper. This third trigger can be another identification of the shipping label at a time after the second trigger is received. In this manner, the period of time between (a) the MV computing device 600 identifying the second trigger (e.g., the first time seeing the shipping label) and (b) the MV computing device 600 identifying the third trigger (e.g., the second time seeing the shipping label) is not recorded so as to conserve storage in the database (e.g., dispatch module database 460 or web server databases 524). This period between the second and third trigger, for example, can be more than one hour. In some examples, period of time can be calculated by the dispatch module 420 to ensure that the item is being fulfilled. For example, the system can set the expected time between the second trigger and the third trigger as a predetermined period of time (e.g., two hours, three hours, four hours, etc.), and if the time period exceeds that predetermined period, an alert can be sent to one or more device to indicate that there is a delay in the fulfillment.

In block 114, the dispatch module 420 can initiate, in response to receiving the third trigger, a second video processing session to save a second video captured by the MV computing device. The second video can include a process of finalizing the transport request.

Method 100 can end after block 114. In some examples, however, method 100 can include additional steps in accordance with the embodiments described herein. For example, and referring again the steps finalize the transport request in block 114, the dispatch module 420 can receive, from a transport system 504, an indication of receipt of the first item. This indication can be received in response to a device associated with the transport system 504 scanning the aforementioned shipping label, thereby indicating to the dispatch module 420 that custody of the ordered item has transferred to the operator of the transport system 504. In some examples, the indication of receipt of the first item can cause the dispatch module 420 to discontinue the second video processing session.

In some examples, the dispatch module 420 can combine the first video and the second video into a single video file to maintain in a database (e.g., dispatch module database 460 or web server databases 524). This can be maintained for future use by stakeholders in the transaction/fulfillment of the item. As described above, the chargebacks can be an issue for customers who purchase items, and they never arrive. The financial institution (e.g., owner and/or operator of financial service provider 530), shipper (e.g., owner and/or operator of transport system 504), or fulfillment center (e.g., owner and/or operator of data processing system 508) may be interested in reviewing the system later to see if the item was ever fulfilled. To this end, the first and second videos can be combined in a file to retrieve if a charge dispute is initiated. Further, the dispatch module 420 can also tag the single (i.e., combined) video file with an order identifier associated with the dispatch request for later inspection. The dispatch module 420 can receive, from a third-party system (e.g., financial service provider 530), a chargeback request to inspect the video pursuant to a dispute. In response to receiving the chargeback request, the dispatch module 420 can transmit, to the third-party system, the single video file tagged with the order identifier.

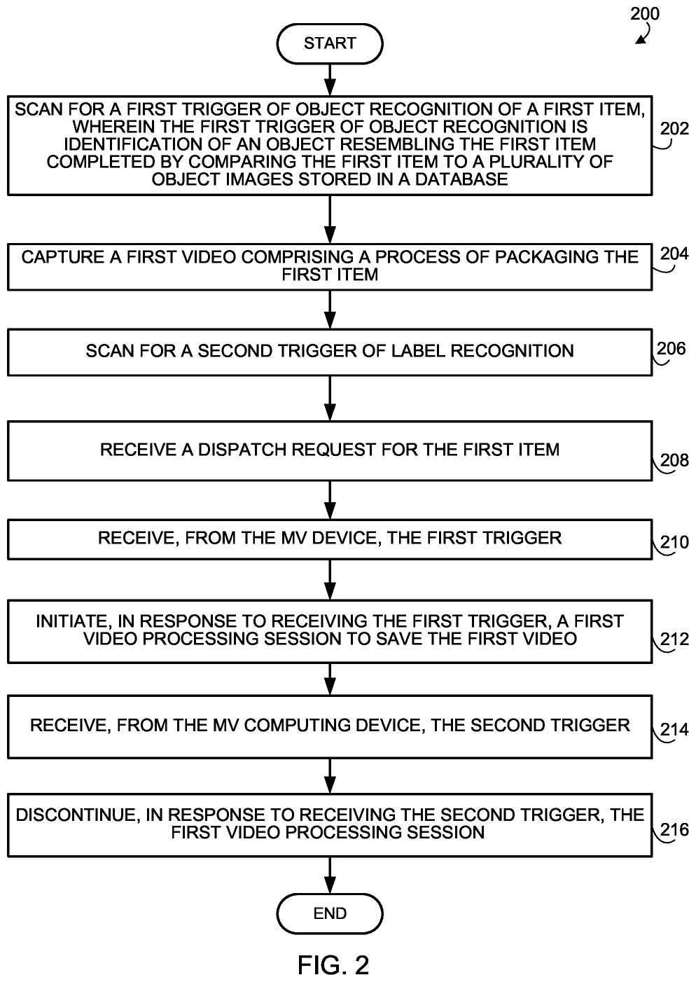

FIG. 2 is a flow diagram illustrating an exemplary method 200 for utilizing machine vision to verify dispatch of items, in accordance with certain embodiments of the disclosed technology. The steps of method 200 can be performed by one or more components of the 500 (e.g., dispatch module 420, web server 510 of data processing system 508, user device 502, and/or MV computing device 600), as described in more detail with respect to FIGS. 4 and 5. In particular, the system performing method 200 can include components of MV computing device 600 and dispatch module 420. This example can include scenarios in which the MV computing device 600 and the dispatch module 420 are operated and/or controlled by a single system, for example a system associated with the fulfilment center for the ordered items. The steps shown in blocks 202 to 206 can be performed by the MV computing device 600; the steps shown in blocks 208 to 216 can be performed by the dispatch module 420. The MV computing device 600 can include a camera (e.g., camera 620).

In block 202, the camera 620 can scan for a first trigger of object recognition of a first item. The first trigger of object recognition can be an identification of an object resembling the first item completed by comparing the first item to a plurality of object images stored in a database (e.g., dispatch module database 460 or web server databases 524). This object recognition can be completed in a manner similar to the scanning for the first trigger of object recognition described herein with respect to block 104 of method 100. Further, and as described above, the object recognition can be completed by communicating with a dispatch module 420 that operates a MLM that can be trained to identify objects captured by the MV computing device and associate them with one or more items, as described above.

In block 204, the camera 620 can capture a first video comprising a process of packaging the first item. This capturing of the first video can be similar to the capturing of the first video described with respect to block 106 of method 100. In block 206, the camera 620 can scan for a second trigger of label recognition. The second trigger of label recognition can be similar to the second trigger described above with respect to block 108 of method 100.

In block 208, the dispatch module 420 can receive a dispatch request for the first item. This step can be similar to the step described above with respect to block 102 of method 100. In block 210, the dispatch module 420 can receive, from the MV device, the first trigger. This step can be similar to the step described above with respect to block 104 of method 100. In block 212, the dispatch module 420 can initiate, in response to receiving the first trigger, a first video processing session to save the first video. This step can be similar to the step described above with respect to block 106 of method 100. In block 214, the dispatch module 420 can receive, from the MV computing device 600, the second trigger. This step can be similar to the step described above with respect to block 108 of method 100. In block 216, the dispatch module 420 can discontinue, in response to receiving the second trigger, the first video processing session.

Method 200 can end after block 216. In some examples, however, method 200 can include additional steps in accordance with the embodiments described herein, including any and all steps described with respect to method 100. For example, the camera 620 can further capture a second video comprising a process of finalizing a transport request. The second video can be captured in response to the dispatch module 420 receiving a third trigger of label recognition associated with the first item, the third trigger being associated with the transport request. This step can be similar to the step described above with respect to block 112 of method 100. The dispatch module 420 can also initiate, in response to receiving the third trigger, a second video processing session to save a second video captured by the MV computing device. The second video can include images of a process of finalizing the transport request. This step can be similar to the step described above with respect to block 116 of method 100. The second trigger of label recognition and the third trigger of label recognition can be identifications, by the MV computing device (e.g., camera 620), of a label associated with the dispatch request (e.g., a shipping label as described above with respect to method 100). Further regarding the finalizing of the transport request or fulfillment, the dispatch module 420 can receive, from a transport system (e.g., transport system 504), an indication of receipt of the first item. The dispatch module 420 can then discontinue, in response to receiving the indication of receipt of the first item, the second video processing session. The first video can be combined with the second video and saved with a tag for later retrieval, as described above.

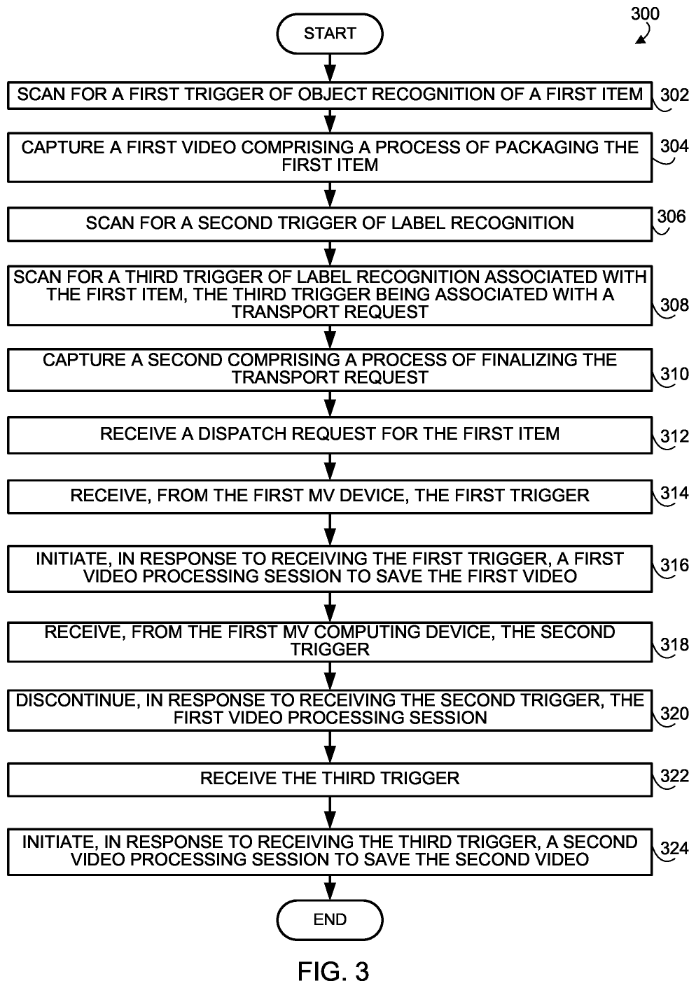

FIG. 3 is a flow diagram illustrating an exemplary method 300 for utilizing machine vision to verify dispatch of items, in accordance with certain embodiments of the disclosed technology. The steps of method 300 can be performed by one or more components of the 500 (e.g., dispatch module 420, web server 510 of data processing system 508, user device 502, MV computing device 600, and/or second MV computing device 700), as described in more detail with respect to FIGS. 4 and 5. In particular, the system performing method 200 can include components of MV computing device 600, second MV computing device 700, and dispatch module 420. This example can include scenarios in which the MV computing device 600, second MV computing device 700, and the dispatch module 420 are operated and/or controlled by a single system, for example a system associated with the fulfilment center for the ordered items. Further, the system is beneficial for fulfilment centers wherein a first portion of the process (e.g., packaging process up until the item is fully boxed) is performed by a MV computing device 600, and wherein a second portion of the process (e.g., finalizing the transport request and setting the item out for delivery to a transport service such as a courier or other shipper) is performed by a second MV computing device 700. The steps shown in blocks 302 to 306 can be performed by the MV computing device 600; the steps shown in blocks 308 and 310 can be performed by the second MV computing device 700; the steps shown in blocks 312 to 324 can be performed by the dispatch module 420. The MV computing device 600 and second MV computing device 700 can include a camera (e.g., cameras 620 and 720).

In block 302, MV computing device 600 can scan for a first trigger of object recognition of a first item. This object recognition can be performed in a manner similar to the step described above with respect to block 104 of method 100. For example, the first trigger can be a label associated with the first item, such as a barcode, including linear- or matrix-barcodes, that identify the item. In other examples, the first trigger of object recognition for the first item can be an identification, by the MV computing device 600, of an object resembling the first item. Further, and as described above, the object recognition can be completed by communicating with a dispatch module 420 that operates a MLM that can be trained to identify objects captured by the MV computing device and associate them with one or more items, as described above. In block 304, MV computing device 600 can capture a first video comprising a process of packaging the first item. This capturing of the first video can be similar to the first video described with respect to block 106 of method 100. In block 306, MV computing device 600 can scan for a second trigger of label recognition. The second trigger of label recognition can be similar to the second trigger described above with respect to block 108 of method 100. For example, the label recognition can be recognition, by the MV computing device 600, of a shipping label.

In block 308, second MV computing device 700 can scan for a third trigger of label recognition associated with the first item. The third trigger can be associated with a transport request. The transport request can be, for example, when the package is provided to a shipper (e.g., transport system 504) or when the package is set at a location in a warehouse so as to provide it to a shipper to deliver it to the customer. This third trigger can be another identification of the shipping label at a time after the second trigger is received by the MV computing device 600. In block 310, second MV computing device 700 can capture a second comprising a process of finalizing the transport request. This step can be similar to the step described above with respect to block 110 of method 100.

Referring again to method 300, in block 312, the dispatch module 420 can receive a dispatch request for the first item. This step can be similar to the step described above with respect to block 102 of method 100. In block 314, the dispatch module 420 can receive, from the MV device, the first trigger. This step can be similar to the step described above with respect to block 104 of method 100. In block 316, the dispatch module 420 can initiate, in response to receiving the first trigger, a first video processing session to save the first video. This step can be similar to the step described above with respect to block 106 of method 100. In block 318, the dispatch module 420 can receive, from the MV computing device 600, the second trigger. This step can be similar to the step described above with respect to block 108 of method 100. In block 320, the dispatch module 420 can discontinue, in response to receiving the second trigger, the first video processing session. This step can be similar to the step described above with respect to block 110 of method 100.

In block 322, the dispatch module 420 can receive, from the second MV computing device and subsequent to discontinuing the first video processing session, the third trigger. At this point, the dispatch module 420 can identify the item as ready to be fulfilled and dispatched to the shipper (i.e., transport system 504). In block 324, the dispatch module 420 can initiate, in response to receiving the third trigger, a second video processing session to save the second video. Method 300 can end after block 324. In some examples, however, method 300 can include additional steps in accordance with the embodiments described herein, including any and all steps described with respect to method 100 and method 200.

FIG. 4 is a block diagram of an example dispatch module 420 used to verify dispatch of items, according to an example implementation of the disclosed technology. According to some embodiments, the user device 502, MV computing device 600, second MV computing device 700, web server 510, transport system 504, and financial provider system 530 as depicted in FIG. 5 and described below, can have a similar structure and components that are similar to those described with respect to dispatch module 420 shown in FIG. 4. As shown, the dispatch module 420 can include a processor 410, an input/output (I/O) device 470, a memory 330 containing an operating system (OS) 440 and a program 450. In certain example implementations, the dispatch module 420 can be a single server or can be configured as a distributed computer system including multiple servers or computers that interoperate to perform one or more of the processes and functionalities associated with the disclosed embodiments. In some embodiments dispatch module 420 can be one or more servers from a serverless or scaling server system. In some embodiments, the dispatch module 420 can further include a peripheral interface, a transceiver, a mobile network interface in communication with the processor 410, a bus configured to facilitate communication between the various components of the dispatch module 420, and a power source configured to power one or more components of the dispatch module 420.

A peripheral interface, for example, can include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface can include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver can be configured to communicate with compatible devices and ID tags when they are within a predetermined range. A transceiver can be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface can provide access to a cellular network, the Internet, or another wide-area or local area network. In some embodiments, a mobile network interface can include hardware, firmware, and/or software that allow(s) the processor(s) 410 to communicate with other devices via wired or wireless networks, whether local or wide area, private or public, as known in the art. A power source can be configured to provide an appropriate alternating current (AC) or direct current (DC) to power components.

The processor 410 can include one or more of a microprocessor, microcontroller, digital signal processor, co-processor or the like or combinations thereof capable of executing stored instructions and operating upon stored data. The memory 330 can include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein can be implemented as a combination of executable instructions and data stored within the memory 330.

The processor 410 can be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 410 can constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 410 can be a single core processor that is configured with virtual processing technologies. In certain embodiments, the processor 410 can use logical processors to simultaneously execute and control multiple processes. The processor 410 can implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the dispatch module 420 can include one or more storage devices configured to store information used by the processor 410 (or other components) to perform certain functions related to the disclosed embodiments. In one example, the dispatch module 420 can include the memory 330 that includes instructions to enable the processor 410 to execute one or more applications, such as server applications, network communication processes, and any other type of application or software known to be available on computer systems. Alternatively, the instructions, application programs, etc. can be stored in an external storage or available from a memory over a network. The one or more storage devices can be a volatile or non-volatile, magnetic, semiconductor, tape, optical, removable, non-removable, or other type of storage device or tangible computer-readable medium.

The dispatch module 420 can include a memory 330 that includes instructions that, when executed by the processor 410, perform one or more processes consistent with the functionalities disclosed herein. Methods, systems, and articles of manufacture consistent with disclosed embodiments are not limited to separate programs or computers configured to perform dedicated tasks. For example, the dispatch module 420 can include the memory 330 that can include one or more programs 450 to perform one or more functions of the disclosed embodiments. For example, in some embodiments, the dispatch module 420 can additionally manage dialogue and/or other interactions with the customer via a program 450.

The processor 410 can execute one or more programs 450 located remotely from the dispatch module 420. For example, the dispatch module 420 can access one or more remote programs that, when executed, perform functions related to disclosed embodiments.

The memory 330 can include one or more memory devices that store data and instructions used to perform one or more features of the disclosed embodiments. The memory 330 can also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 can include software components that, when executed by the processor 410, perform one or more processes consistent with the disclosed embodiments. In some embodiments, the memory 330 can include a dispatch module database 460 for storing related data to enable the dispatch module 420 to perform one or more of the processes and functionalities associated with the disclosed embodiments.

The dispatch module database 460 can include stored data relating to status data (e.g., average session duration data, location data, idle time between sessions, and/or average idle time between sessions) and historical status data. According to some embodiments, the functions provided by the dispatch module database 460 can also be provided by a database that is external to the dispatch module 420, such as the database 516 as shown in FIG. 5.

The dispatch module 420 can also be communicatively connected to one or more memory devices (e.g., databases) locally or through a network. The remote memory devices can be configured to store information and can be accessed and/or managed by the dispatch module 420. By way of example, the remote memory devices can be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The dispatch module 420 can also include one or more I/O devices 470 that can comprise one or more interfaces for receiving signals or input from devices and providing signals or output to one or more devices that allow data to be received and/or transmitted by the dispatch module 420. For example, the dispatch module 420 can include interface components, which can provide interfaces to one or more input devices, such as one or more keyboards, mouse devices, touch screens, track pads, trackballs, scroll wheels, digital cameras, microphones, sensors, and the like, that enable the dispatch module 420 to receive data from a user (such as, for example, via the user device 502).

In examples of the disclosed technology, the dispatch module 420 can include any number of hardware and/or software applications that are executed to facilitate any of the operations. The one or more I/O interfaces can be utilized to receive or collect data and/or user instructions from a wide variety of input devices. Received data can be processed by one or more computer processors as desired in various implementations of the disclosed technology and/or stored in one or more memory devices.

The dispatch module 420 can contain programs that train, implement, store, receive, retrieve, and/or transmit one or more machine learning models. Machine learning models can include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models can include an ensemble model (e.g., a model comprised of a plurality of models). In some embodiments, training of a model can terminate when a training criterion is satisfied. Training criterion can include a number of epochs, a training time, a performance metric (e.g., an estimate of accuracy in reproducing test data), or the like. The dispatch module 420 can be configured to adjust model parameters during training. Model parameters can include weights, coefficients, offsets, or the like. Training can be supervised or unsupervised.

The dispatch module 420 can be configured to train machine learning models by optimizing model parameters and/or hyperparameters (hyperparameter tuning) using an optimization technique, consistent with disclosed embodiments. Hyperparameters can include training hyperparameters, which can affect how training of the model occurs, or architectural hyperparameters, which can affect the structure of the model. An optimization technique can include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The dispatch module 420 can be configured to optimize statistical models using known optimization techniques.

The dispatch module 420 can be configured to generate a similarity metric based on data model output, including data model output representing a property of the data model. For example, dispatch module 420 can be configured to generate a similarity metric based on activation function values, embedding layer structure and/or outputs, convolution results, entropy, loss functions, model training data, or other data model output). For example, a synthetic data model can produce first data model output based on a first dataset and a produce data model output based on a second dataset, and a similarity metric can be based on a measure of similarity between the first data model output and the second-data model output. In some embodiments, the similarity metric can be based on a correlation, a covariance, a mean, a regression result, or other similarity between a first data model output and a second data model output. Data model output can include any data model output as described herein or any other data model output (e.g., activation function values, entropy, loss functions, model training data, or other data model output). In some embodiments, the similarity metric can be based on data model output from a subset of model layers. For example, the similarity metric can be based on data model output from a model layer after model input layers or after model embedding layers. As another example, the similarity metric can be based on data model output from the last layer or layers of a model.

While the dispatch module 420 has been described as one form for implementing the techniques described herein, other, functionally equivalent, techniques can be employed. For example, some or all of the functionality implemented via executable instructions can also be implemented using firmware and/or hardware devices such as application specific integrated circuits (ASICs), programmable logic arrays, state machines, etc. Furthermore, other implementations of the dispatch module 420 can include a greater or lesser number of components than those illustrated.

FIG. 5 is a block diagram of an example system that can be used to view and interact with data processing system 508, according to an example implementation of the disclosed technology. The components and arrangements shown in FIG. 5 are not intended to limit the disclosed embodiments as the components used to implement the disclosed processes and features can vary. As shown, data processing system 508 can interact with a user device 502 via a network 506. In certain example implementations, the data processing system 508 can include a local network 512, a dispatch module 420, a web server 510, and a database 516.

In some embodiments, a user can operate the user device 502. The user device 502 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 506 and ultimately communicating with one or more components of the data processing system 508. In some embodiments, the user device 502 can include or incorporate electronic communication devices for hearing or vision impaired users.

Users may include individuals such as, for example, subscribers, clients, prospective clients, or customers of an entity associated with an organization, such as individuals who have obtained, will obtain, or can obtain a product, service, or consultation from or conduct a transaction in relation to an entity associated with the data processing system 508. For example, the user of user device 502 can be a customer that makes an order, for example at a vendor that then communicates with a financial service provider 530 to complete the order. According to some embodiments, the user device 502 can include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 506 can be of any suitable type, including individual connections via the internet such as cellular or WiFi networks. In some embodiments, the network 506 can connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted can be personal or confidential, security concerns can dictate one or more of these types of connections be encrypted or otherwise secured. In some embodiments, however, the information being transmitted can be less personal, and therefore the network connections can be selected for convenience over security.

The network 506 can include any type of computer networking arrangement used to exchange data. For example, the network 506 can be the Internet, a private data network, virtual private network (VPN) using a public network, and/or other suitable connection(s) that enable(s) components in the system 500 environment to send and receive information between the components of the system 500. The network 506 can also include a PSTN and/or a wireless network.

The data processing system 508 can be associated with and optionally controlled by one or more entities such as a business, corporation, individual, partnership, or any other entity that provides one or more of goods, services, and consultations to individuals such as customers. In some embodiments, the data processing system 508 can be controlled by a third party on behalf of another business, corporation, individual, partnership. The data processing system 508 can include one or more servers and computer systems for performing one or more functions associated with products and/or services that the organization provides.

Web server 510 can include a computer system configured to generate and provide one or more websites accessible to customers, as well as any other individuals involved in access system 508's normal operations. Web server 510 can include a computer system configured to receive communications from user device 502 via for example, a mobile application, a chat program, an instant messaging program, a voice-to-text program, an SMS message, email, or any other type or format of written or electronic communication. Web server 510 can have one or more processors 522 and one or more web server databases 524, which can be any suitable repository of website data. Information stored in web server 510 can be accessed (e.g., retrieved, updated, and added to) via local network 512 and/or network 506 by one or more devices or systems of system 500. In some embodiments, web server 510 can host websites or applications that can be accessed by the user device 502. For example, web server 510 can host a financial service provider website that a user device can access by providing an attempted login that are authenticated by the dispatch module 420. According to some embodiments, web server 510 can include software tools, similar to those described with respect to user device 502 above, that can allow web server 510 to obtain network identification data from user device 502. The web server can also be hosted by an online provider of website hosting, networking, cloud, or backup services, such as Microsoft Azure™ or Amazon Web Services™.

The local network 512 can include any type of computer networking arrangement used to exchange data in a localized area, such as WiFi, Bluetooth™, Ethernet, and other suitable network connections that enable components of the data processing system 508 to interact with one another and to connect to the network 506 for interacting with components in the system 500 environment. In some embodiments, the local network 512 can include an interface for communicating with or linking to the network 506. In other embodiments, certain components of the data processing system 508 can communicate via the network 506, without a separate local network 506.

The data processing system 508 can be hosted in a cloud computing environment (not shown). The cloud computing environment can provide software, data access, data storage, and computation. Furthermore, the cloud computing environment can include resources such as applications (apps), VMs, virtualized storage (VS), or hypervisors (HYP). User device 502 can be able to access data processing system 508 using the cloud computing environment. User device 502 can be able to access data processing system 508 using specialized software. The cloud computing environment can eliminate the need to install specialized software on user device 502.

In accordance with certain example implementations of the disclosed technology, the data processing system 508 can include one or more computer systems configured to compile data from a plurality of sources the dispatch module 420, web server 510, and/or the database 516. The dispatch module 420 can correlate compiled data, analyze the compiled data, arrange the compiled data, generate derived data based on the compiled data, and store the compiled and derived data in a database such as the database 516. According to some embodiments, the database 516 can be a database associated with an organization and/or a related entity that stores a variety of information relating to customers, transactions, ATM, and business operations. The database 516 can also serve as a back-up storage device and can contain data and information that is also stored on, for example, database 460, as discussed with reference to FIG. 4.

### Example Use Case

The following example use case describes an example of a typical user flow pattern. This section is intended solely for explanatory purposes and not in limitation.

Steven decides to purchase a new laptop for his personal business, and selects one on an online marketplace to be shipped to his house. Steven checks out in the marketplace and provides a credit card number he has from National Bank. National Bank then sends an order confirmation number to the marketplace, and the marketplace transmits a dispatch request to its fulfilment center to pack and set the laptop out for shipment.

Robert, an employee at the fulfilment center, receives an indication of the dispatch request and retrieves the ordered laptop. Robert wears a machine vision (MV) headset that includes a camera that is directed toward Robert's field of view. The MV headset identifies a barcode associated with the laptop in the field of view and then triggers a dispatch module of the fulfilment center to start recording Robert's work. Robert boxes the laptop, tapes the box shut, prints a shipping label, and places the label on the box. When the MV headsets detects the shipping label, which includes a scannable barcode, the MV headset communicates with the dispatch module to discontinue saving the recorded video stream of the headset.

A few hours later, a common carrier is ready to retrieve the package, and Robert (or another employee wearing a second headset) retrieves the package and his MV headset identifies the shipping label again, which triggers the dispatch module of the fulfilment center to start recording again as the packaged laptop is delivered to the common carrier. Once the common carrier receives the package, the worker scans the shipping label barcode, and the dispatch module discontinues saving the second video footage. The dispatch module then combines the two videos of the process into one file, and tags the video file with the order number in case it is needed later. The fulfilment center has a policy to save these combined, labeled videos for 60 days.

Twenty days pass, and Robert never received his laptop. National Bank then communicates with the fulfilment center and retrieves the combined video file. Since the video file shows the entire steps of the fulfilment until it is transferred to the common carrier, then National Bank knows that the logistical mishap must have happened after custody was transferred to the carrier.

In some examples, disclosed systems or methods can involve one or more of the following clauses:

Clause 1: A system comprising a dispatch module, the dispatch module comprising: one or more processors; and a memory in communication with the one or more processors and storing instructions that, when executed by the one or more processors, are configured to cause the dispatch module to: receive a dispatch request for a first item; receive, from a machine vision (MV) computing device, a first trigger of object recognition for the first item; initiate, in response to receiving the first trigger, a first video processing session to save a first video captured by the MV computing device, the first video comprising a process of packaging the first item; receive, from the MV computing device, a second trigger of label recognition associated with the first item; discontinue, in response to receiving the second trigger, the first video processing session; receive, from the MV computing device and subsequent to discontinuing the first video processing session, a third trigger of label recognition associated with the first item, the third trigger being associated with a transport request; and initiate, in response to receiving the third trigger, a second video processing session to save a second video captured by the MV computing device, the second video comprising a process of finalizing the transport request.

Clause 2: The system of Clause 1, wherein the instructions are further configured to cause the dispatch module to: receive, from a transport system, an indication of receipt of the first item; and discontinue, in response to receiving the indication of receipt of the first item, the second video processing session.

Clause 3: The system of Clause 2, wherein the instructions are further configured to cause the dispatch module to combine the first video and the second video into a single video file to maintain in a database.

Clause 4: The system of Clause 3, wherein the instructions are further configured to cause the dispatch module to: tag the single video file with an order identifier associated with the dispatch request; and receive, from a third-party system, a chargeback request; and transmit, to the third-party system, the single video file tagged with the order identifier in response to receiving the chargeback request.

Clause 5: The system of any of Clauses 1 to 4, wherein the MV computing device is an MV headset with an integrated camera, the camera being configured to (i) scan for the first trigger of object recognition, (ii) scan for the second trigger of label recognition, and (iii) capture the first video and the second video.

Clause 6: The system of any of Clauses 1 to 5, wherein: the first trigger of object recognition for the first item is an identification, by the MV computing device, of a first label associated with the first item; and the second trigger of label recognition is an identification, by the MV computing device, of a second label associated with the dispatch request.

Clause 7: The system of any of Clauses 1 to 6, wherein the first trigger of object recognition for the first item is an identification, by the MV computing device, of an object resembling the first item.

Clause 8: The system of Clause 7, wherein the instructions are further configured to cause the dispatch module to train a machine learning model (MLM) to identify objects captured by the MV computing device and associate them with one or more items, and wherein MLM learns in response to receiving the second trigger of label recognition, thereby indicating that the object resembles the first item.

Clause 9: The system of any of Clauses 1 to 8, wherein the second trigger of label recognition and the third trigger of label recognition are identifications, by the MV computing device, of a label associated with the dispatch request.

Clause 10: The system of any of Clauses 1 to 9, wherein the second trigger of label recognition and the third trigger of label recognition are separated temporally by more than one hour.

Clause 11: A system comprising: a machine vision (MV) computing device comprising a camera configured to: scan for a first trigger of object recognition of a first item, wherein the first trigger of object recognition is identification of an object resembling the first item completed by comparing the first item to a plurality of object images stored in a database; capture a first video comprising a process of packaging the first item; and scan for a second trigger of label recognition; and a dispatch module comprising: one or more processors; and a memory in communication with the one or more processors and storing instructions that, when executed by the one or more processors, are configured to cause the dispatch module to: receive a dispatch request for the first item; receive, from the MV device, the first trigger; initiate, in response to receiving the first trigger, a first video processing session to save the first video; receive, from the MV computing device, the second trigger; and discontinue, in response to receiving the second trigger, the first video processing session.

Clause 12: The system of Clause 11, wherein the camera is further configured to capture a second video captured by the MV computing device, the second video comprising a process of finalizing a transport request, and wherein the instructions are further configured to cause the dispatch module to: receive, from the MV computing device and subsequent to discontinuing the first video processing session, a third trigger of label recognition associated with the first item, the third trigger being associated with the transport request; and initiate, in response to receiving the third trigger, a second video processing session to save a second video captured by the MV computing device, the second video comprising a process of finalizing the transport request.

Clause 13: The system of Clause 12, wherein the second trigger of label recognition and the third trigger of label recognition are identifications, by the MV computing device, of a label associated with the dispatch request.

Clause 14: The system of Clause 12, wherein the instructions are further configured to cause the dispatch module to: receive, from a transport system, an indication of receipt of the first item; and discontinue, in response to receiving the indication of receipt of the first item, the second video processing session.

Clause 15: The system of Clause 14, wherein the instructions are further configured to cause the dispatch module to combine the first video and the second video into a single video file to maintain in the database.

Clause 16: The system of Clause 15, wherein the instructions are further configured to cause the dispatch module to: tag the single video file with an order identifier associated with the dispatch request; and receive, from a third-party system, a chargeback request; and transmit, to the third-party system, the single video file tagged with the order identifier in response to receiving the chargeback request.

Clause 17: The system of any of Clauses 11 to 16, wherein the instructions are further configured to cause the dispatch module to train a machine learning model (MLM) to identify objects captured by the MV computing device and associate them with one or more items, and wherein MLM learns in response to receiving the second trigger of label recognition, thereby indicating that first item resembles the object.

Clause 18: A system comprising: a first machine vision (MV) computing device comprising a first camera configured to: scan for a first trigger of object recognition of a first item; capture a first video comprising a process of packaging the first item; and scan for a second trigger of label recognition; and a second MV computing device comprising a second camera configured to: scan for a third trigger of label recognition associated with the first item, the third trigger being associated with a transport request; and capture a second video comprising a process of finalizing the transport request; and a dispatch module comprising: one or more processors; and a memory in communication with the one or more processors and storing instructions that, when executed by the one or more processors, are configured to cause the dispatch module to: receive a dispatch request for the first item; receive, from the first MV device, the first trigger; initiate, in response to receiving the first trigger, a first video processing session to save the first video; receive, from the first MV computing device, the second trigger; discontinue, in response to receiving the second trigger, the first video processing session; receive, from the second MV computing device and subsequent to discontinuing the first video processing session, the third trigger; and initiate, in response to receiving the third trigger, a second video processing session to save the second video.

Clause 19: The system of Clause 18, wherein the instructions are further configured to cause the dispatch module to: receive, from a transport system, an indication of receipt of the first item; and discontinue, in response to receiving the indication of receipt of the first item, the second video processing session.

Clause 20: The system of Clause 19, wherein the instructions are further configured to cause the dispatch module to combine the first video and the second video into a single video file to maintain in a database.

The features and other aspects and principles of the disclosed embodiments can be implemented in various environments. Such environments and related applications can be specifically constructed for performing the various processes and operations of the disclosed embodiments or they can include a general-purpose computer or computing platform selectively activated or reconfigured by program code to provide the necessary functionality. Further, the processes disclosed herein can be implemented by a suitable combination of hardware, software, and/or firmware. For example, the disclosed embodiments can implement general purpose machines configured to execute software programs that perform processes consistent with the disclosed embodiments. Alternatively, the disclosed embodiments can implement a specialized apparatus or system configured to execute software programs that perform processes consistent with the disclosed embodiments. Furthermore, although some disclosed embodiments can be implemented by general purpose machines as computer processing instructions, all or a portion of the functionality of the disclosed embodiments can be implemented instead in dedicated electronics hardware.

The disclosed embodiments also relate to tangible and non-transitory computer readable media that include program instructions or program code that, when executed by one or more processors, perform one or more computer-implemented operations. The program instructions or program code can include specially designed and constructed instructions or code, and/or instructions and code well-known and available to those having ordinary skill in the computer software arts. For example, the disclosed embodiments can execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms can be used as building blocks for a framework, however certain implementations of the system can autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component can be, but is not limited to being, a process running on a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, can be repeated, or may not necessarily need to be performed at all, according to some embodiments or implementations of the disclosed technology.

These computer-executable program instructions can be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions can also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology can provide for a computer program product, including a computer-usable medium having a computer-readable program code or program instructions embodied therein, said computer-readable program code adapted to be executed to implement one or more functions specified in the flow diagram block or blocks. Likewise, the computer program instructions can be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices can include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology can be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described can include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features can alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising a dispatch module, the dispatch module comprising:
one or more processors; and
a memory in communication with the one or more processors and storing instructions that, when executed by the one or more processors, are configured to cause the dispatch module to:
receive a dispatch request for a first item;
receive, from a machine vision (MV) computing device, a first trigger of object recognition for the first item;
initiate, in response to receiving the first trigger, a first video processing session to save a first video captured by the MV computing device, the first video comprising a process of packaging the first item;
receive, from the MV computing device, a second trigger of label recognition associated with the first item;
discontinue, in response to receiving the second trigger, the first video processing session;
receive, from the MV computing device and subsequent to discontinuing the first video processing session, a third trigger of label recognition associated with the first item, the third trigger being associated with a transport request; and
initiate, in response to receiving the third trigger, a second video processing session to save a second video captured by the MV computing device, the second video comprising a process of finalizing the transport request.

2. The system of claim 1, wherein the instructions are further configured to cause the dispatch module to:
receive, from a transport system, an indication of receipt of the first item; and
discontinue, in response to receiving the indication of receipt of the first item, the second video processing session.

3. The system of claim 2, wherein the instructions are further configured to cause the dispatch module to combine the first video and the second video into a single video file to maintain in a database.

4. The system of claim 3, wherein the instructions are further configured to cause the dispatch module to:
tag the single video file with an order identifier associated with the dispatch request; and
receive, from a third-party system, a chargeback request; and
transmit, to the third-party system, the single video file tagged with the order identifier in response to receiving the chargeback request.

5. The system of claim 1, wherein the MV computing device is an MV headset with an integrated camera, the camera being configured to (i) scan for the first trigger of object recognition, (ii) scan for the second trigger of label recognition, and (iii) capture the first video and the second video.

6. The system of claim 1, wherein:
the first trigger of object recognition for the first item is an identification, by the MV computing device, of a first label associated with the first item; and
the second trigger of label recognition is an identification, by the MV computing device, of a second label associated with the dispatch request.

7. The system of claim 1, wherein the first trigger of object recognition for the first item is an identification, by the MV computing device, of an object resembling the first item.

8. The system of claim 7, wherein the instructions are further configured to cause the dispatch module to train a machine learning model (MLM) to identify objects captured by the MV computing device and associate them with one or more items, and wherein MLM learns in response to receiving the second trigger of label recognition, thereby indicating that the object resembles the first item.

9. The system of claim 1, wherein the second trigger of label recognition and the third trigger of label recognition are identifications, by the MV computing device, of a label associated with the dispatch request.

10. The system of claim 1, wherein the second trigger of label recognition and the third trigger of label recognition are separated temporally by more than one hour.

11. A system comprising:
a machine vision (MV) computing device comprising a camera configured to:
scan for a first trigger of object recognition of a first item, wherein the first trigger of object recognition is identification of an object resembling the first item completed by comparing the first item to a plurality of object images stored in a database;
capture a first video comprising a process of packaging the first item; and
scan for a second trigger of label recognition; and
a dispatch module comprising:
one or more processors; and
a memory in communication with the one or more processors and storing instructions that, when executed by the one or more processors, are configured to cause the dispatch module to:
receive a dispatch request for the first item;
receive, from the MV device, the first trigger;
initiate, in response to receiving the first trigger, a first video processing session to save the first video;
receive, from the MV computing device, the second trigger; and
discontinue, in response to receiving the second trigger, the first video processing session.

12. The system of claim 11, wherein the camera is further configured to capture a second video captured by the MV computing device, the second video comprising a process of finalizing a transport request, and wherein the instructions are further configured to cause the dispatch module to:
receive, from the MV computing device and subsequent to discontinuing the first video processing session, a third trigger of label recognition associated with the first item, the third trigger being associated with the transport request; and
initiate, in response to receiving the third trigger, a second video processing session to save a second video captured by the MV computing device, the second video comprising a process of finalizing the transport request.

13. The system of claim 12, wherein the second trigger of label recognition and the third trigger of label recognition are identifications, by the MV computing device, of a label associated with the dispatch request.

14. The system of claim 12, wherein the instructions are further configured to cause the dispatch module to:
receive, from a transport system, an indication of receipt of the first item; and
discontinue, in response to receiving the indication of receipt of the first item, the second video processing session.

15. The system of claim 14, wherein the instructions are further configured to cause the dispatch module to combine the first video and the second video into a single video file to maintain in the database.

16. The system of claim 15, wherein the instructions are further configured to cause the dispatch module to:
tag the single video file with an order identifier associated with the dispatch request; and
receive, from a third-party system, a chargeback request; and
transmit, to the third-party system, the single video file tagged with the order identifier in response to receiving the chargeback request.

17. The system of claim 11, wherein the instructions are further configured to cause the dispatch module to train a machine learning model (MLM) to identify objects captured by the MV computing device and associate them with one or more items, and wherein MLM learns in response to receiving the second trigger of label recognition, thereby indicating that first item resembles the object.

18. A system comprising:
a first machine vision (MV) computing device comprising a first camera configured to:
scan for a first trigger of object recognition of a first item;
capture a first video comprising a process of packaging the first item; and
scan for a second trigger of label recognition; and
a second MV computing device comprising a second camera configured to:
scan for a third trigger of label recognition associated with the first item, the third trigger being associated with a transport request; and
capture a second video comprising a process of finalizing the transport request; and
a dispatch module comprising:
one or more processors; and
a memory in communication with the one or more processors and storing instructions that, when executed by the one or more processors, are configured to cause the dispatch module to:
receive a dispatch request for the first item;
receive, from the first MV device, the first trigger;
initiate, in response to receiving the first trigger, a first video processing session to save the first video;
receive, from the first MV computing device, the second trigger;
discontinue, in response to receiving the second trigger, the first video processing session;
receive, from the second MV computing device and subsequent to discontinuing the first video processing session, the third trigger; and
initiate, in response to receiving the third trigger, a second video processing session to save the second video.

19. The system of claim 18, wherein the instructions are further configured to cause the dispatch module to:
receive, from a transport system, an indication of receipt of the first item; and
discontinue, in response to receiving the indication of receipt of the first item, the second video processing session.

20. The system of claim 19, wherein the instructions are further configured to cause the dispatch module to combine the first video and the second video into a single video file to maintain in a database.
